(19) United States
(12) Patent Application Publication
(10) Pub. No.: US 2026/0158564 A1
(43) Pub. Date: Jun. 11, 2026

(54) CUTTING INSERT WITH COOLING CHANNELS, A NOZZLE, A BASE PLATE, AND A TOOL HOLDER THEREFOR

(71) Applicant: No Screw Ltd., Hevel Modi'in (IL)

(72) Inventor: Gershon Harif, Ramat Gan (IL)

(21) Appl. No.: 18/706,434

(22) PCT Filed: Nov. 2, 2022
(86) PCT No.: PCT/IL2022/051158

§ 371 Date: May 1, 2024

(30) Foreign Application Priority Data
Nov. 4, 2021 (IL) 287851
May 30, 2022 (IL) 293464

(51) Int. Cl. B23C 5/28; B23B 51/00; B23B 51/06

(52) U.S. Cl. CPC B23C 5/283; B23B 51/0003; B23B 51/0684; B23C 5/282; B23C 5/285; B23C 2200/0455; B23C 2200/083; B23C 2200/203

(57) ABSTRACT

Cutting tools including cutting inserts, which perform the actual machining. Such cutting inserts are associated with cooling arrangements, separate from the cutting insert, which are configured for external provision of cooling fluid to a cutting corner region of the cutting insert. A cooling cavity having a cooling surface proximal to the cutting corner region is configured for receiving therein the cooling fluid for cooling the cooling surface and thereby withdrawing heat from the cutting corner region. During manufacture of the cutting insert, a coating may be applied to portions of the cutting insert to increase durability; however, to increase thermal conductivity, the cooling surface, is left free of the coating material.

### TECHNOLOGICAL FIELD

This invention relates to cutting tools and cutting inserts, in particular cutting tools and cutting inserts comprising internal cooling mechanisms.

### BACKGROUND ART

References considered to be relevant as background to the presently disclosed subject matter are listed below:
U.S. 9,095,913B2
U.S. 9,656,323B2

Acknowledgement of the above references herein is not to be inferred as meaning that these are in any way relevant to the patentability of the presently disclosed subject matter.

### BACKGROUND

It is known in the art to provide a cooling fluid, i.e. coolant, to a cutting interface of a cutting tool during a cutting operation on a workpiece. Provision of the cooling fluid cools the cutting interface during the cutting operation, thereby preventing damage to both the cutting edge and the workpiece.

In general, cutting tools have a rake face and at least one relief face, defining, at the intersection thereof, the tool's cutting edge. Cooling fluid is generally provided to the cutting interface, either from the side of the rake face, or from the side of the relief face, or from both external cooling supply arrangements.

Cutting tools may also include cutting inserts, which perform the actual machining. Such cutting inserts are associated with cooling arrangements, separate from the cutting insert, which are configured for external provision of cooling fluid to the cutting insert.

Conventional cutting inserts may have a cutting corner region defined between a first side surface, second side surface and one of the upper surface and a lower surface. A cooling cavity, including a cooling surface proximal to the cutting corner region, is configured for receiving therein the cooling fluid for cooling the cooling surface, and thereby withdraw heat from the cutting corner region. Typically, the entire cutting corner region is coated with a coating to increase durability; however, the coating may decrease the thermal conductivity of the cooling surface, reducing the effectiveness thereof. Accordingly, an object of the present disclosure is to increase thermal conductivity of the cooling surface by leaving the cooling surface free of the coating material, which covers the remainder of the cutting corner region.

### GENERAL DESCRIPTION

In accordance with a first aspect of the presently disclosed subject matter there can be provided a cutting insert comprising a body having a pair of upper and lower parallel horizontal surfaces and at least three sidewalls extending therebetween, and comprising at least one cutting corner region defined between two, first and second, adjacent sidewalls and the upper horizontal surface, and a cooling portion associated with said cutting corner region, said cutting corner region having a rake surface at the corresponding horizontal surface, a first relief surface at the first side sidewall, a second relief surface at the second sidewall, and having respective first and second cutting edge portions and a curved cutting edge portion therebetween, each cooling portion comprising:
a cooling channel formed in the corresponding horizontal surface, open to an exterior of the insert along a depth thereof, the cooling channel extending between a coolant inlet and a coolant outlet and comprising an upstream section associated with the coolant inlet, extending towards the curved cutting edge portion along and spaced from the first cutting edge portion, a downstream section associated with the coolant outlet, extending away from the curved cutting edge portion and extending along and spaced from the second cutting edge portion, and a curved section interconnecting the upstream and downstream sections and extending along the curved cutting corner and spaced therefrom; and
a nozzle receiving through-bore extending from the lower horizontal surface towards the upper horizontal surface, such that the coolant inlet merges with the nozzle receiving through-bore at least along a majority of the depth of the cooling channel at the coolant inlet, so as to allow a nozzle to be introduced therein from at least the lower horizontal surface for directing coolant into the cooling channel via the coolant inlet for the coolant to flow along the cooling channel via the upstream, curved and downstream sections towards the coolant outlet, in order to facilitate heat removal from the cutting corner region.

In accordance with a second aspect of the presently disclosed subject matter there can be provided a nozzle that can be used with a tool holder on which a cutting insert according to any one of the previous designs can be configured to be mounted. The nozzle can be configured to be received within the nozzle receiving through-bore of the cutting insert and have a proximal end to be associated with the tool holder and a distal end associated with the upper horizontal surface of the insert when the nozzle is fully received in the nozzle receiving through-bore, where the nozzle comprises an outlet orifice spaced from the distal end to a distance corresponding to the depth of the cooling channel at the coolant inlet. The nozzle can be configured for being assembled with the tool holder to which the insert can be to be mounted, and optionally integrally assembled therewith, or unitarily formed with the tool holder.

The tool holder can be a part of a tool holder assembly, which also comprises, at least in use, a base plate via which the insert can be to be mounted on the tool holder, and wherein the nozzle can be assembled with the base plate, and optionally integrally assembled therewith, or unitarily formed with the base plate. The nozzle has a vertical axis and the outlet orifice has an orifice axis oriented transversely to the vertical axis.

In accordance with a third aspect of the presently disclosed subject matter there can be provided a cutting insert comprising:
an upper surface, a lower surface and a plurality of side surfaces extending therebetween, the plurality of side surfaces including a first side surface and a second side surface adjacent to the first side surface,
a cutting corner region defined between the first side surface, the second side surface and one of the upper surface and the lower surface,
a first coating material on the cutting corner region, and
a cooling cavity having a cooling surface proximal to the cutting corner region, said cooling cavity being configured for receiving therein a cooling fluid for cooling said cooling surface and thereby withdraw heat from the cutting corner region, said cooling cavity, at least at its cooling surface, being free of said first coating material.

In accordance with a fourth aspect of the presently disclosed subject matter there can be provided a masking arrangement for use in the coating process of the cutting insert, the masking arrangement can comprises a masking element comprising at least one fitting portion having corresponding dimensions to at least a portion of the cooling cavity including said cooling surface, said at least one fitting portion being configured for mounting in said cooling cavity during said coating process such that each fitting portion covers and thereby protects at least said cooling surface from being coated.

In accordance with a fifth aspect of the presently disclosed subject matter there can be provided a method for partially coating at least one cutting insert comprising an upper surface, a lower surface and a number of side surfaces extending therebetween, and comprising a cutting corner region defined between two, first and second, adjacent side surfaces and one of the upper and lower surfaces, and a cooling cavity having a cooling surface proximal to the cutting corner region, said cooling cavity being configured for receiving therein a cooling fluid for cooling said cooling surface and thereby withdraw heat from the cutting corner region, said method comprising:
a. providing a masking arrangement comprising a masking element including at least one fitting portion having corresponding dimensions to at least a portion of the cooling cavity including said cooling surface;
b. mounting said at least one fitting portion in said cooling cavity of the cutting insert such that said fitting portion covers said cooling surface to form a masked insert assembly;
c. coating said masked insert assembly with a coating material having a lower heat conductivity value than that of the cutting insert.

Any one or more of the following featured designs and configurations can be applied to any of the aspects of the present disclosure, separately or in combinations thereof:

The curved section of the cooling channel can be spaced from the cutting edge to a distance at least not exceeding that of the upstream section.

The cooling channel can have a channel bottom, a first wall, and a second wall extending from the channel bottom to the corresponding horizontal surface, the first wall being closer to the cutting edge than the second wall. The inclination of the first wall relative to a horizontal plane passing through the channel bottom, varies so that in the curved section the inclination can be greater than adjacent to the coolant inlet. The second wall can comprise a chip breaking formation at an area of the second wall close to the corresponding horizontal surface.

The depth of the cooling channel along at least the curved section can be between 0.5 mm to 1 mm, more specifically between 0.65 to 0.85 mm, and, even more specifically, can be about 0.7 mm. The first and second walls can have top edges and the width of the cooling channel between these top edges can be in the range of 0.6 mm to 1 mm, more specifically between 0.7 to 0.8 mm, and even more specifically, can be about 0.75 mm.

The nozzle receiving through-bore can be configured to enable the nozzle to be inserted therein only in a single orientation.

The cutting insert can be double-sided, and said cooling channel constitutes an upper cooling channel in fluid communication with the nozzle receiving through-bore at an area thereof adjacent the upper horizontal surface, and the cutting insert has a lower cooling channel in fluid communication with the nozzle receiving through-bore at an area thereof adjacent the lower horizontal surface, and wherein the nozzle receiving through-bore can be configured to receive a nozzle from both upper and lower horizontal surfaces.

The cutting insert can comprise at least two cutting edges and two cooling channels at each of its upper and lower horizontal surfaces and at least two corresponding nozzle receiving through-bores, each associated with one upper cooling channel and one lower cooling channel.
the cutting insert can have a central axis X and the nozzle receiving through-bore can have a bore axis Xb defining a vertical plane with the central axis, where the cooling channel in the upper horizontal surface can be positioned at one side of the vertical plane and the cooling channel in the lower horizontal surface can be positioned at an opposite side of the plane.

The cutting insert can comprise four cutting corner regions on each of the upper and lower horizontal surfaces.

The nozzle receiving through-bore can be opened to the exterior of the insert at the sidewall closest thereto.

The nozzle receiving through-bore can be disposed at a central area of the cutting insert, and thus constitutes a central nozzle receiving through-bore. The central nozzle receiving through-bore can be associated with at least two cooling channels disposed at the upper horizontal surface and with at least two cooling channels disposed at the lower horizontal surface, each channel having a coolant inlet portion extending between a coolant inlet at the nozzle receiving through-bore and the upstream section of the cooling channel. In some cases, at least a portion of the nozzle receiving through-bore can constitute an insert mounting bore for mounting the cutting insert to a tool holder.

The upstream section can have a first end associated with the coolant inlet and second end associated with the curved section, the first end being disposed further from the cutting edge than the second end.

The cooling cavity can comprise a channel having a coolant inlet and a coolant outlet different from the coolant inlet and having the cooling surface disposed therebetween.

The cooling cavity can extend inwardly from one of the upper and lower surfaces.

The cooling cavity can have at least a surface exposed to the exterior of the cutting insert which is free from being coated with said first coating material.

The cooling surface of the cooling cavity can be exposed to the exterior of the cutting insert.

The cooling surface can also face in the direction of the exterior of the cutting insert.

The entire cooling cavity can free of said coating material.

The cooling cavity can extend from a corresponding one of said upper surface and said lower surface.

The cooling cavity can be encompassed by the corresponding one of the upper surface and the lower surface; and wherein at least a portion of the corresponding one of the upper surface and the lower surface, including the cutting corner region, can be coated with said first coating material.

The entire corresponding one of the upper surface and the lower surface encompassing the cooling cavity can be coated with said coating material.

The cutting insert can comprise a central axis extending normal to the one of the upper surface and the lower surface, wherein the cooling cavity can extend along an axis perpendicular to the central axis towards the cutting corner region.

The channel can comprises an upstream section associated with the coolant inlet, extending towards the cutting corner region along and spaced from the first side surface, a downstream section associated with the coolant outlet, extending away from the cutting corner region and extending along and spaced from the second side surface, and a curved section associated with the cooling surface interconnecting the upstream and downstream sections.

The cooling cavity can comprise a cavity having a single opening constituting both the coolant inlet and the coolant outlet.

The cooling cavity can have a maximal depth which is less than half the distance between the upper and lower surfaces.

The cutting insert can comprise a material having a first thermal conductivity, wherein the first coating material can have a second thermal conductivity lower than the first thermal conductivity.

The boundaries between coated and uncoated portions of the cutting insert can be distinct from each other.

The cooling cavity, at least at its cooling surface, can be coated with a second coating material different from the first coating material of the cutting corner region.

The cooling surface can be not coated with any coating material.

The cutting insert can be a first cutting insert, and the at least one fitting portion can be further configured, while being mounted on said cooling cavity of said first cutting insert, to be mounted with and support a second cutting insert in a spaced apart manner with respect to the first cutting insert.

The second cutting insert can be identical to the first cutting insert, and the at least one fitting portion can include: a first fitting portion positioned at a first end of the masking element, and a second fitting portion positioned on an opposite end thereof, configured to fit within a cooling cavity of said second cutting insert.

The cutting insert can comprise two or more cooling cavities, and wherein the at least fitting portion can comprise a plurality of fitting portions, each configured to be mounted in a respective cooling cavity.

The plurality of fitting portions can be configured with an identical shape.

The plurality of fitting portions can be positioned differently relative to one another.

The cutting insert can comprises two or more cooling cavities, and the masking arrangement can comprise a plurality of conjoined fitting portions, each configured to be mounted to a respective cooling cavity.

The masking element and the fitting portions can comprise a single body.

The masking element can comprise a base having one or more fitting sockets and a corresponding number of the plurality of fitting portions fitted therein.

The masking arrangement can comprise a plurality of bases each configured with a single set of the plurality of fitting portions protruding therefrom.

The at least one cutting insert can be a plurality of cutting inserts, and said at least one fitting portion can be a plurality of fitting portions, each configured to be mounted with and support one of the plurality of cutting inserts in a spaced apart manner, and the method can further comprise, prior to step (c), stacking the plurality of fitting portions and the plurality of cutting inserts, such that the plurality of cutting inserts are spaced from each other by the plurality of fitting portions.

In accordance with a sixth aspect of the presently disclosed subject matter there can be provided a cutting insert partially coated by the aforementioned method.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a perspective view of a cutting insert according to an example of the presently disclosed subject matter;

FIG. 1B is an enlarged plan view of a cutting corner region of the cutting insert of FIG. 1A;

FIG. 1C is a cross sectional view along a plane I-I in FIG. 1A, which a cutting insert of the presently disclosed subject matter may have, the plane I-I passing through two upper and two lower cutting corner regions;

FIG. 1D is a perspective view of a coolant dispensing nozzle, according to an example of the presently disclosed subject matter, for use with the cutting insert of FIG. 1A;

FIG. 2A is a perspective view of a cutting insert according to another example of the presently disclosed subject matter, when mounted on a base plate with a coolant dispensing nozzle received in a nozzle receiving through-bore of the cutting insert;

FIG. 2B is a perspective view of the base plate assembled with the coolant dispensing nozzle of FIG. 2A;

FIG. 2C is a cross sectional view of the cutting insert of FIG. 2A along a plane II-II passing through two upper and two lower cutting corner regions, and an axis of the nozzle receiving through-bore;

FIG. 2D is an enlarged cross-sectional view of the coolant dispensing nozzle of FIG. 2C;

FIG. 3A is a perspective view of a cutting insert with a central nozzle receiving through-bore and a cover, according to another example of the presently disclosed subject matter;

FIG. 3B is a perspective view of a base plate and a coolant dispensing nozzle configured for use with the cutting insert of FIG. 3A;

FIG. 3C is a plan view of the cutting insert of FIG. 3A without the cover;

FIG. 3D is a cross sectional view of the cutting insert of FIG. 3A when mounted on the base plate with the coolant dispensing nozzle of FIG. 3B received in the nozzle receiving through-bore of the cutting insert along a plane III-III shown in FIG. 3C passing through two upper and two lower cooling channels;

FIG. 3E is an enlarged cross-sectional view of the coolant dispensing nozzle of FIG. 3B;

FIG. 3F is an exploded view of the cutting insert of FIG. 3A with a coolant dispensing nozzle thereof;

FIG. 4A is a perspective view of an assembly including a cutting tool holder, a base plate and a cutting insert, according to an example of the presently disclosed subject matter;

FIG. 4B is an exploded view of the assembly of FIG. 4A;

FIG. 5A is a perspective view of a cutting insert according to a further example of the presently disclosed subject matter;

FIG. 5B is an enlarged plan view of a cutting corner region of the cutting insert of FIG. 5A;

FIG. 6A is a perspective view of a cutting tool holder, having the cutting insert of FIG. 3A mounted thereon;

FIG. 6B is a cross sectional view of the cutting tool of FIG. 7A, taken along a plane IV-IV;

FIG. 7 is an enlarged plan view of a cutting corner region of the cutting insert, according to further example of the presently disclosed subject matter;

FIG. 8A is a cross sectional view, which a cooling channel in any of the cutting inserts of FIGS. 1A, 3A, 5A, and any other cutting insert of the presently disclosed subject matter may have, the cross sectional view being taken at the area of merging of an upstream section and a curved section of the cooling channel perpendicular to horizontal surfaces of the cutting insert (such as, e.g., plane V-V in FIG. 7);

FIG. 8B is another cross sectional view, which a cooling channel in any of the cutting insert of FIGS. 1A, 3A, 5A, and any other cutting insert of the presently disclosed subject matter may have, the cross sectional view being taken at the same area as in FIG. 8A;

FIG. 8C is a cross sectional view, which the cooling channel of FIG. 8A may have, the cross sectional view being taken at the area of merging of a curved section and a downstream section of the cooling channel perpendicular to horizontal surfaces of the cutting insert (such as, e.g., plane VI-VI in FIG. 7); and

FIG. 8D is another cross sectional view, which a cooling channel of FIG. 8B may have, the cross sectional view being taken at the same area as in FIG. 8C.

FIGS. 9A to 9C are perspective views of a milling tool holder comprising a cutting insert of FIG. 5A;

FIGS. 10A and 10B are front and perspective views of a drilling tool holder comprising a cutting insert according to a further example of the presently disclosed subject matter;

FIG. 10C is a perspective view of the cutting insert shown in FIGS. 9A and 9B;

FIG. 11A is a cross-sectional view of a cutting corner region with coating added, except in the cooling channel;

FIG. 11B is a cross-sectional view of a cutting corner region with coating added, except in some portions of the cooling channel;

FIG. 12A is a perspective view of a masking arrangement for use in a coating process of a cutting insert;

FIG. 12B is an exploded view of the masking arrangement of FIG. 10A;

FIG. 12C is a top view of the masking arrangement of FIG. 10A;

FIG. 12D is a side view of the masking arrangement of FIG. 10A;

FIG. 13A is a perspective view of a stacked masking arrangement;

FIG. 13B is a side view of an alternative stacked masking arrangement; and

FIG. 14 is a flow chart of a method of coating a cutting insert.

### DETAILED DESCRIPTION OF EMBODIMENTS

The presently disclosed subject matter generally relates to a cutting insert having at least one cutting edge associated with a cutting corner region of the cutting insert, and comprising a cooling portion configured to allow introduction of cooling fluid thereto during a cutting operation performed on a workpiece. During such cutting operation, the cutting corner region is continuously heated to high temperatures due to high friction between itself and the workpiece. The cooling fluid is purposed to flow in the cooling portion and thereby absorb and remove heat transferred thereto from the cutting corner region. As a result, the cutting corner region is effectively cooled during the cutting operation and the wear occurring as a result of its operation is reduced. The cooling portion can be positioned proximal to the cutting corner region, to enable the cooling fluid to effectively withdraw heat therefrom, and can be formed with a cooling cavity for receiving the cooling fluid. The cooling cavity can be in the form of an interior canal, i.e., radially bounded along its length by the cutting insert, or in the form of an open channel, i.e., at least partially open to the exterior of the cutting insert so as to enable fluid to flow therein with a free surface.

To enable effective extraction of heat from the cutting edge, at least a part of the cooling cavity is disposed in the cutting corner region, in the vicinity of the cutting edge while being spaced therefrom, to minimize structural damage to its integrity. The cooling cavity is configured to receive cooling fluid, i.e. coolant, at a coolant inlet end and let it flow therealong to a coolant outlet end, for removing heat from the cutting corner region, i.e., the cutting edge and, particularly, from an area of the cutting insert disposed between the cutting edge and the cooling cavity.

It will be appreciated that in the present disclosure and claims, terms relating to direction, such as top and bottom, upper and lower, up and down, etc., and similar/related terms, are used with reference to the accompanying drawings, unless indicated otherwise or clear from the context, and should not be construed as limiting. The terms “horizontal” with respect to a surface or line of an element, e.g., a cutting insert, normally means that the surface/line is generally horizontal when the element in its working orientation is located on a horizontal base, and the term “vertical” with respect to a surface/line of the element means that the surface/line is generally vertical when the element in its normal orientation is located on a horizontal base. The term ‘front’ (and similar terms) refers to a direction towards a workpiece and the term ‘rear’ (and other similar terms) refers to a direction away from the workpiece.

A cutting insert according to the presently disclosed subject matter comprises an upper surface, a lower surface and a plurality of side surfaces extending therebetween, the plurality of side surfaces including a first side surface and a second side surface adjacent to the first side surface. A cutting corner region is defined between the first side surface, the second side surface and one of the upper surface and the lower surface.

According to an embodiment of the presently disclosed subject matter, the cutting insert, i.e., at least the cutting corner region thereof, is coated with a first coating material having reduced thermal conductivity with respect to the cutting corner region, to provide greater endurance to heat of the cutting corner region, reduce the affect of heat generated in the working process of the cutting corner region, and to increase the lifetime of the cutting insert. The cooling cavity can have a cooling surface proximal to the cutting corner region, which can be free of said first coating material to achieve the opposite effect to enhance heat transfer between the fluid flowing in the cavity and the cutting corner region, i.e, to enhance thermal conductivity, and thereby to enhance heat absorption from the cutting corner region.

According to an embodiment of the presently disclosed subject matter, the cutting insert can be configured to receive a coolant dispensing nozzle within the body of the cutting insert for delivering cooling fluid at a desired orientation to the inlet end of the cooling cavity. The nozzle can be assembled or constitute a unitary body with a base plate and/or a cutting tool holder, on which the cutting insert is to be mounted.

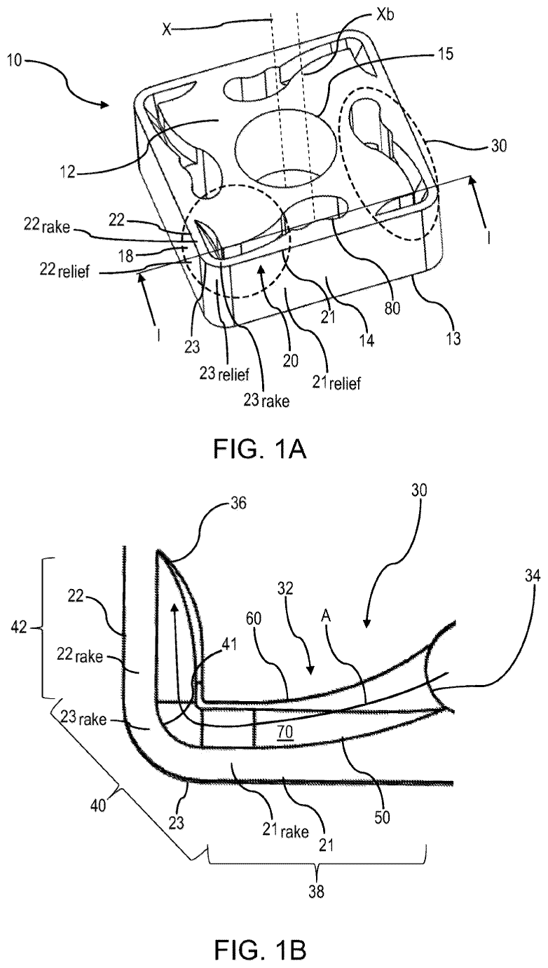

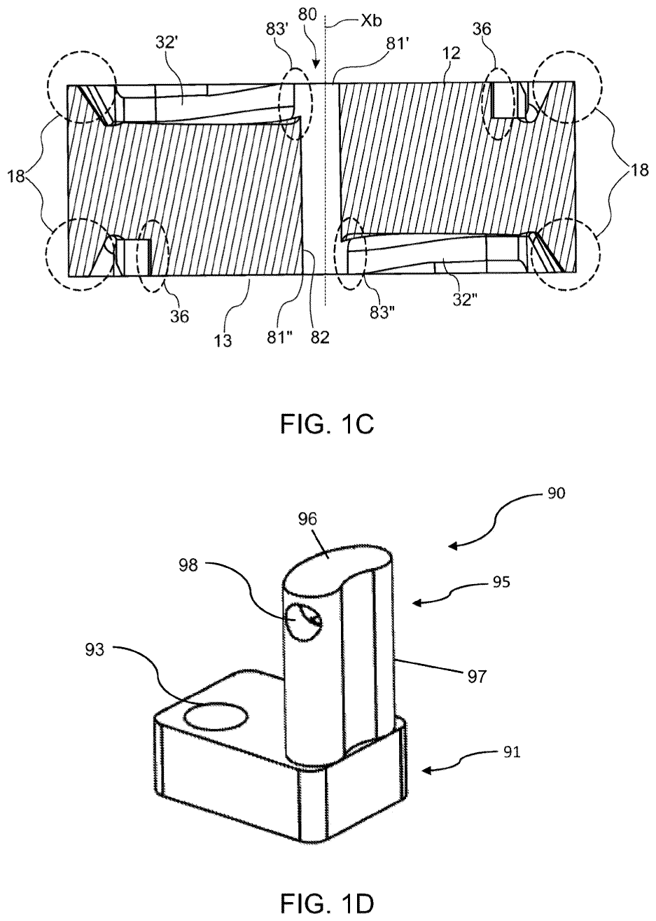

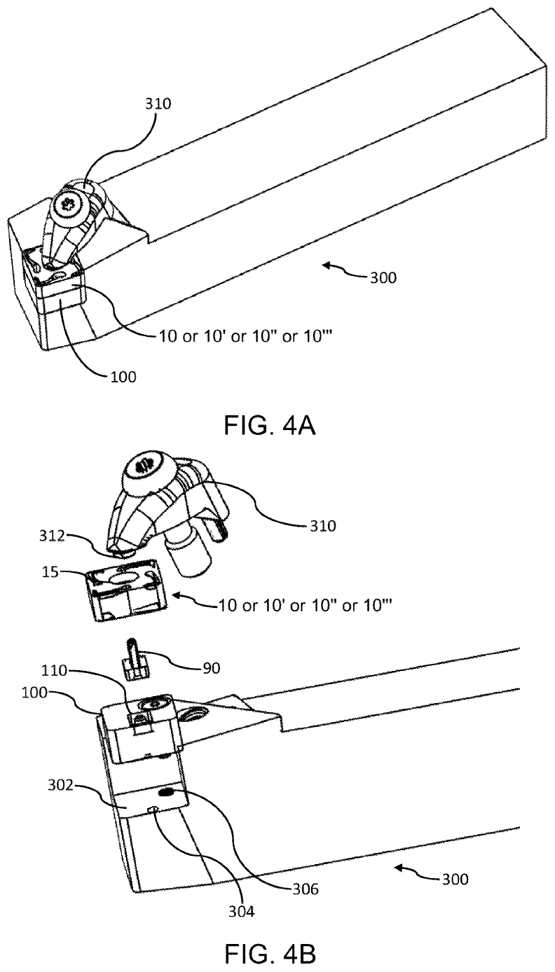

FIGS. 1A-1C illustrate a cutting insert 10 according to one example of the presently disclosed subject matter. The cutting insert 10 has two horizontal surfaces, an upper horizontal surface 12 and a lower horizontal surface 13, which are generally parallel to each other, and side-walls 14 extending therebetween and having a generally vertical orientation. The cutting insert 10 comprises a mounting component, e.g. a mounting bore 15, configured for engaging a fastening element, e.g. clamp 310, by which the cutting insert 10 can be fixedly held on a cutting tool holder 300 or base plate 100, see FIGS. 4A and 4B.

The mounting bore 15 can be in the form of a vertical through bore and the fastening element can be in the form of a screw configured to be received therein and to be threaded into a corresponding insert receiving seat in a tool holder. In other cases, the mounting bore can be configured for being engaged by a clamping device 310 associated with the tool holder 300. For example, the mounting bore 15 can have upper and lower recesses, which are concentric with a central axis of the cutting insert 10, and have a partition therebetween, into which the clamping device 310 can be inserted for fixedly attaching the cutting insert to the cutting tool holder 10.

In the example of FIG. 1A-1C, the mounting bore 15 is a centrally disposed through-bore extending between the upper horizontal surface 12 and the lower horizontal surface 13 of the cutting insert 10 and has an axis constituting a central axis X of the cutting insert 10.

The cutting insert 10 has a generally square configuration and is double-sided. More particularly, the cutting insert 10 has eight similar upper and lower cutting corner regions 18, each having a cutting edge 20 defined at the intersection of associated areas of one of the horizontal upper and lower surfaces 12 and 13 and two adjacent side-walls 14. The cutting insert 10 thus has 8 indexable cutting edges 20.

In other examples, a cutting insert 10 according to the presently disclosed subject matter can have different configurations and a number of indexable cutting corner regions with cutting edges. For example, the cutting insert 10 can have indexable cutting edges only at its upper surface, or can be double sided, but have less or more than four indexable cutting edges on each side. The cutting insert 10 can have a polygonal shape other than square, or can have a generally circular shape.

The cutting edges 20 of the cutting insert 10 each have a first cutting edge portion 21, a second cutting edge portion 22, and a curved corner cutting edge portion 23 therebetween, in which case the areas of the upper and lower horizontal surfaces 12 and 13 adjacent the first, second and corner cutting edge portions 21, 22 and 23, respectively, of the cutting edge 20 constitute its respective first, second and corner rake surfaces, 21ᵣₐₖₑ, 22ᵣₐₖₑ and 23ᵣₐₖₑ, respectively, and areas of the sidewalls 14 adjacent the first, second and corner portions 21, 22 and 23, respectively, of each cutting edge 20 constitute its respective first, second and corner relief surfaces 21_{relief}, 22_{relief} and 23_{relief}, respectively.

In the further description of the cutting insert 10 of FIG. 1A, reference will be made only to one cutting corner region 18 with a cutting edge 20 and a cooling portion in the form of a cooling cavity 30 associated therewith. The cutting edge has a first cutting edge portion 21, a second cutting edge portion 22, and a curved cutting edge corner portion 23 therebetween. The first cutting edge portion 21 has a first relief surface 21_{relief} and a first rake surface 21ᵣₐₖₑ, the second cutting edge portion 22 has a second relief surface 22_{relief} and a second rake surface 22rake and the curved corner cutting edge portion 23 has a corner relief surface 23_{relief} and a corner rake surface 23ᵣₐₖₑ.

It should be understood that the description regarding one cutting edge 20 and its associated cooling portion should be considered as being applicable to each of the cutting edges 20 of the cutting insert 10 and its corresponding cooling cavity 30.

The cooling cavity 30 comprises an elongated curved cooling cavity in the form of a cooling channel 32 extending between inlet and outlet ends, 34, 36 of the cooling channel 32, at least a portion of which extends along the corresponding cutting edge 20, while being spaced from the cutting edge 20. In the present description and claims, the term “channel” means a region having at least one coolant directing wall, at least a part of which is spaced from the remainder of the horizontal surface associated with the cutting edge 20 in the direction towards the other horizontal surface. The cooling channel 32 can have a single coolant directing wall, to function in a manner similar to a banked turn, or it can be in the form of a trough carved into and extending from the corresponding horizontal surface, e.g. the upper surface or the lower surface, and have two coolant directing walls, at different distances from their associated cutting edge portion.

With respect to FIG. 1B, the cutting corner region 18 comprises a cooling channel 32 in the form of a trough carved into and extending from the upper horizontal surface 12. The cooling channel 32 has a coolant inlet end 34 adjacent the first cutting edge portion 21, a coolant outlet end 36 adjacent the second cutting edge portion 22, a first, outer coolant directing wall 50, and a second, inner coolant directing wall 60 opposite thereto. The cooling channel 32 comprises an upstream section 38 extending away from the coolant inlet end 34 towards the cutting corner region 18 and along the first cutting edge portion 21, a downstream section 42 extending from the cutting corner region 18 and along the second cutting edge portion 22, towards the coolant outlet end 36, and a curved section 40 connecting therebetween and curving generally along the curved corner cutting edge portion 23, on which a cooling surface 41 is disposed most proximal to the cutting edge.

The cooling channel 32, in particular its geometry and orientation relative to the coolant inlet end 34, can be configured so as to enable directional flow of the coolant along the cooling channel 32 at a desired speed, for providing a sufficient amount of surface area exposed to the coolant, and for mitigating the amount of fluid escaping from the coolant channel 32 prior to reaching the coolant outlet end 34. For example, the upstream section 38 of the cooling channel 32 can be at least slightly curved to provide the coolant flow with a radial speed vector prior to its entrance into the curved section 40.

Additionally, or alternatively, the outer coolant directing wall 50 of the cooling channel 32, at least at the upstream portion thereof, can have inclination relative to a horizontal plane towards the corresponding cutting edge 20, gradually increasing from the coolant inlet end 34 towards the curved section 40, and optionally maintaining its increased inclination along the curved section 40.

The width of the cooling channel 32, as seen in a plan view thereof, can also vary along its length. For example, the upstream section 50 can have a first width adjacent to the coolant inlet end 34 and a second reduced width adjacent to the curved section 40, so as to increase the pressure of coolant flow therein at the entrance to the curved section 40. The width of the cooling channel 32 along the curved section 40 can be greater than that at the upstream section 38. The width of the cooling channel 32 along its downstream section 42 can be the same as, smaller than, or greater than that in the curved section 40.

In some examples of a cutting insert 10 of the presently disclosed subject matter, the width of the cooling channel 32 and its distance from the cutting edge 20 can be selected so that, at pre-determined conditions under which the cutting insert 10 is to be used in a cutting operation, chips formed during the cutting operation will cover the cooling channel 32, thereby improving the cooling efficiency at the covered portions thereof.

In FIG. 1B, the cooling channel 32 is shown in operation, in which a directional flow of coolant is provided, and is designated by arrow A. To enable such flow, the upstream section 38 of the cooling channel 32 is curved from its coolant inlet end 34 towards the curved section 40, so as to provide the coolant flow with a radial speed vector towards the central axis X prior to its entrance into the curved section 40. The upstream section 38 has a width gradually decreasing from adjacent to the coolant inlet end 34, towards the curved section 40.

In order to supply coolant fluid to the cooling channels 32 of the cutting insert 10, the cutting insert 10 comprises at least one nozzle receiving through-bore 80, extending between the two horizontal surfaces 12 and 13 and configured to receive therein a coolant directing nozzle 90. Each nozzle receiving through-bore 80 extends along a vertical axis parallel to the central axis X of the cutting insert 10, and has a geometric shape enabling the coolant dispensing nozzle 90 (hereinafter nozzle) to be received therein. The nozzle receiving through-bore 80 can be configured to enable the nozzle 90 to be inserted into the nozzle receiving through-bore 80 from either one of the horizontal surfaces 12 and 13 to the other, thereby enabling indexable use of the cutting insert 10. Each of the nozzle receiving through-bores 80 is in fluid communication with one or more cooling channels 32 by means of respective one or more bore outlet openings spaced from each other along the height of the bore 80. When the cutting insert 10 is double-sided, its at least one nozzle-receiving bore 80 can have a bore upper outlet in fluid communication with a cooling channel 32 in the upper horizontal surface 12, and a bore lower outlet in fluid communication with a cooling channel 32 in the lower horizontal surface 13 for providing coolant fluid thereto when the insert is turned over.

Reverting to FIG. 1A, the cutting insert 10 comprises four nozzle receiving through-bores 80, and, as seen in FIG. 1C, each nozzle receiving through-bore 80 extends between the upper and lower horizontal surfaces 12 and 13, along a bore axis Xb which is parallel to the central axis X of the cutting insert 10. Each nozzle receiving through-bore 80 comprises a bore upper end 81′ at the upper horizontal surface 12, a bore lower end 81″ at the lower horizontal surface 13, a sidewall 82 extending therebetween, a bore upper outlet opening 83′ in the sidewall 82 adjacent to and spaced from the bore upper end 81′, and a bore lower outlet opening 83″ in the sidewall 82 adjacent to and spaced from the bore lower end 81″. As seen in FIG. 1C, the bore upper outlet opening 83′ coincides with the coolant inlet end 34 of the cooling channel 32 at the upper horizontal surface 12 of the cutting insert 10, and the bore lower outlet opening 83″ coincides with the coolant inlet 34 end of the cooling channel 32 at the lower horizontal surface 13 of the cutting insert 10. The former cooling channel is designated as 32′ and it extends to the left from the bore upper outlet opening 83′, and the latter cooling channel is designated as 32″ and it extends to the right of the bore lower outlet opening 83″.

The nozzle 90 and the nozzle receiving through-bore 80 can have such a cross-sectional shape, so as to allow the nozzle 90 to be inserted into the bore 80 only in such orientation, in which the nozzle 90 is aligned with the bore upper outlet opening 83′ of the cutting insert 10 for dispensing coolant in an optimal manner.

As seen in FIGS. 1A and 1B, the nozzle receiving through-bore 80 has an irregular shape, mating that of the nozzle 90 of FIG. 1D, to allow the nozzle 90 to be inserted into the bore 80 only in such orientation, in which the nozzle 90 is aligned with the bore upper outlet opening 83′.

The nozzle 90 has an elongated hollow body 95 of a height corresponding to that of the nozzle receiving through bore 80 and having a nozzle lower end with a nozzle inlet 92, at which coolant can be introduced into the nozzle 90, a closed nozzle upper end 96, a nozzle sidewall 97 axially extending therebetween, and a nozzle outlet 98 formed in the nozzle sidewall 97, so that, when pressurized, coolant enters the nozzle 90 at the open lower end, and it exits the nozzle 90 from the nozzle outlet 98 opening in a radial direction. The nozzle 90 can constitute a part of, or can be assembled with a base plate or insert seat in a tool holder 300, to which the insert 20 is to be mounted. To facilitate such assembly, the nozzle 90 can have a base 91 associated with the nozzle lower end that can be fitted within a dedicated socket/recess formed in the base plate or insert seat, and via which coolant can enter the nozzle 90. The base 91 has a footprint larger than that of the nozzle upper end 96.

One example of a nozzle 90 configured to be received in a nozzle receiving through bore 80 of the cutting insert 10 of FIG. 1A, is illustrated in FIG. 1D. The nozzle 90 has a base 91 and an elongated hollow body 95 extending vertically therefrom. The base 91 constitutes a nozzle lower end having a nozzle inlet 92 via which coolant can be axially introduced into the nozzle 90, and a base mounting bore 93, through which the nozzle 90 can be mounted, for example via a connector, to the base plate or tool holder. The elongated hollow body 95 has a closed nozzle upper end 96, nozzle sidewall 97 axially extending from the base 91 to the nozzle upper end 96, and a nozzle outlet 98 formed in the nozzle sidewall 97 so that, when coolant under pressure enters the nozzle axially at the open lower end, it exits the nozzle 90 from the nozzle outlet 98 in a radial direction.

In any nozzle 90 according to the presently disclosed subject matter, the nozzle outlet 90 may have a configuration facilitating entrance of a coolant flow into the cooling channel 32 in a desired orientation/direction. In particular, the desired orientation of the nozzle outlet 98 relative to the coolant inlet end 34 of the cooling channel 32 can be achieved by an irregular cross-sectional shape of the nozzle 90 and the nozzle receiving through-bore 80, causing the nozzle outlet 98 to be disposed in a certain position with respect to the cooling channel 32 when the nozzle 90 is received within the nozzle receiving through-bore 80. Also, the nozzle outlet 98 can be directed to a portion of the first cutting edge 21 prior to its merger with the curved corner cutting edge portion 23, such that the coolant will be dispensed with radial speed vectors enhancing its flow in the cooling channel 23.

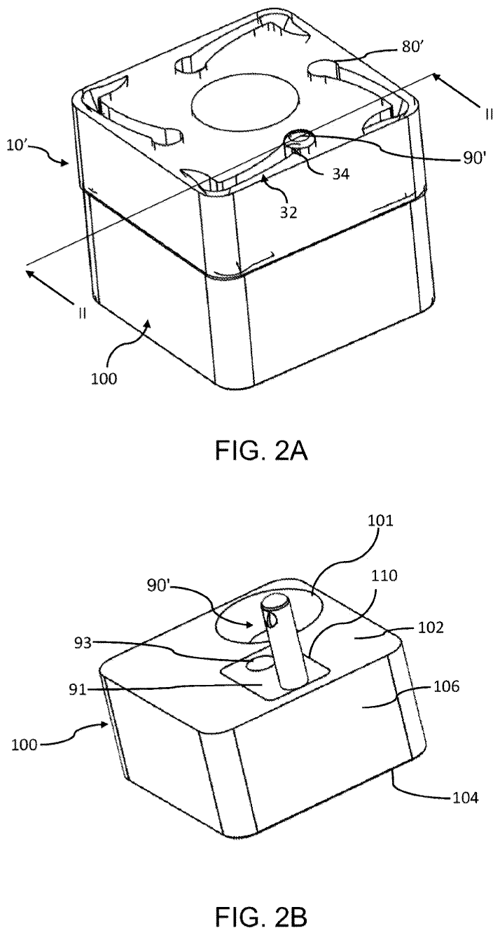

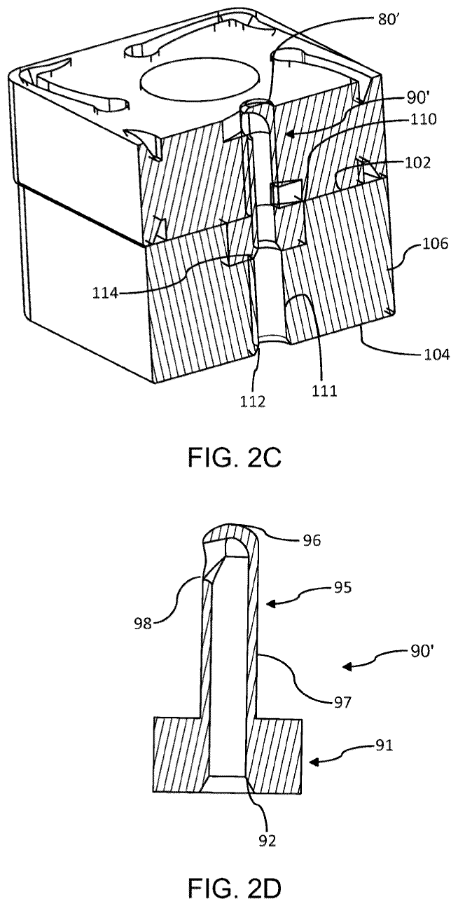

Alternatively, the desired orientation of the nozzle 90 relative to the coolant inlet end 34 of the cooling channel 32 can be achieved by mounting thereof to a base plate in a predetermined orientation. In this case, the nozzle 90 and the nozzle receiving through-bore 80 can have a regular cross-sectional shape. One example of this option is illustrated in FIGS. 2A to 2D, which show a cutting insert 10′ with its nozzle receiving through-bore 80′ and coolant dispensing nozzle 90′ having a circular cross-sectional shape. The above description of the cutting insert 10 is fully applicable to the cutting insert 10′, except for the shape of its nozzle receiving through-bore 80 and coolant dispensing nozzle 90.

If a base plate 100 is to be used for mounting of a cutting insert 10′ of the presently disclosed subject matter, to a tool holder 300, such a base plate 100 can have an insert facing surface 102, upon which the corresponding cutting insert 10′ can be mounted, a tool facing surface 104, and base sidewalls 106 extending therebetween. The insert facing surface 102 may be formed correspondingly with the lower horizontal surface 13 and the side-walls 14 of the corresponding cutting insert 10′. The insert facing surface 102 can have a nozzle receiving recess 110 formed therein configured to accommodate at least a portion of the nozzle 90, specifically at a predetermined orientation. The base plate 100 can also comprise a coolant pipe 111 passing from an inlet 112 formed at the tool facing surface 104, to an outlet 114 formed at the nozzle receiving recess 110 for providing coolant to the portion of the coolant dispensing nozzle 90 accommodated therein, and, specifically, to be snuggly fitted therein, so as to be flush with the insert facing surface 102.

In the example of FIGS. 2A-2D, a base plate 100 is used with the cutting insert 10′ and comprises an insert facing surface 102, a tool facing surface 104 and base plate sidewalls 106 extending therebetween. The insert facing surface 102 has holder connecting bore 101, through which it can be connected via a connector to a cutting tool holder 300, and a nozzle receiving recess 110 formed therein to accommodate at least a portion of the nozzle 90′ and shaped to do so at a predetermined orientation. The base plate 100 comprises a coolant pipe 111 passing from an inlet 112 formed at the tool facing surface 104, to an outlet 114 formed at the nozzle receiving recess 110 for providing coolant to the portion of the coolant dispensing nozzle 90′ accommodated therein.

The nozzle receiving through-bore 80 or 80′ can be disposed between the horizontal surfaces 12 and 13 while being sufficiently spaced from the associated cutting edge 20, so as to prevent mechanical failure thereof up to the mounting bore 15, e.g. in the middle between two opposite corners of the cutting insert 10 or 10′. In some cases, the nozzle receiving through-bore 80 or 80′ can be located centrally and constitute a portion of the mounting bore 15 itself.

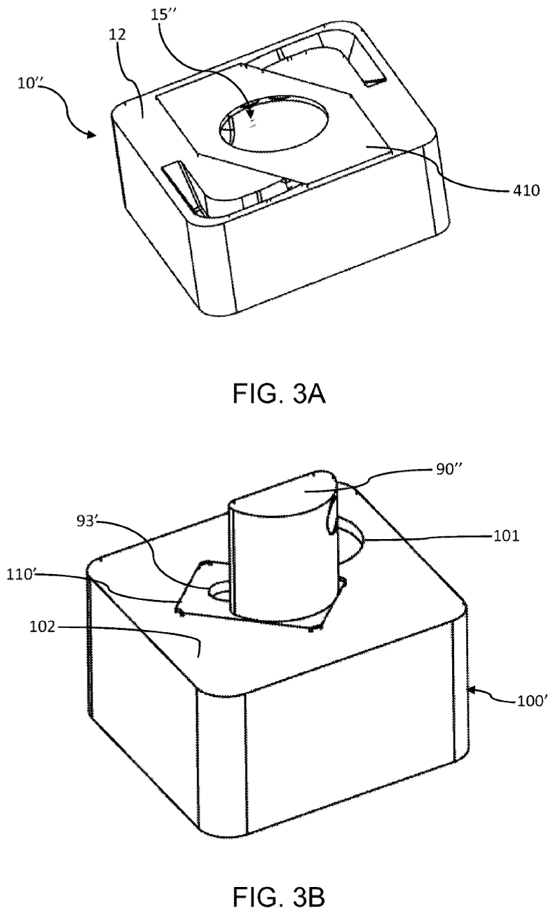

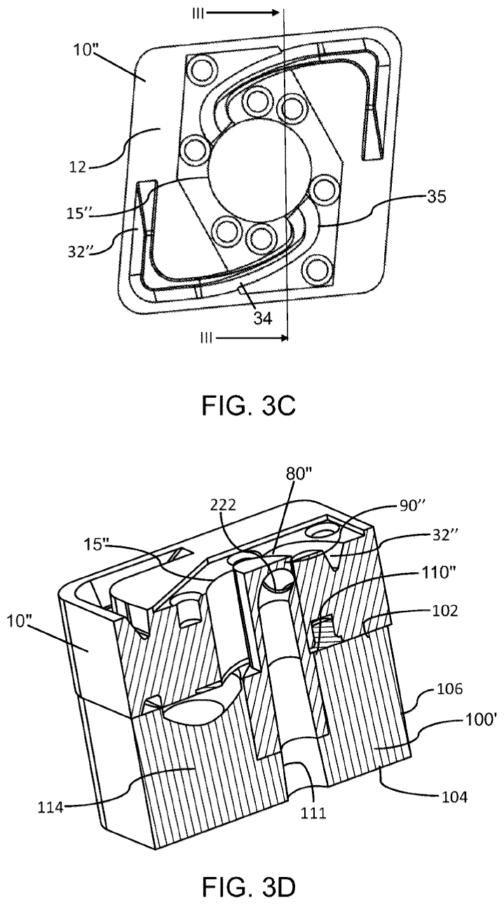

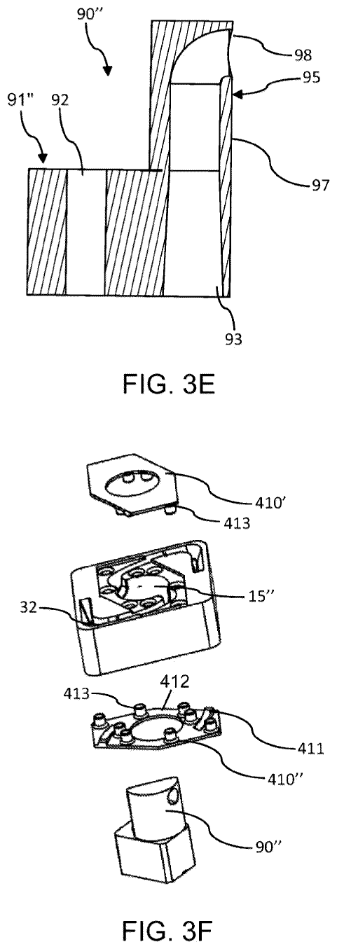

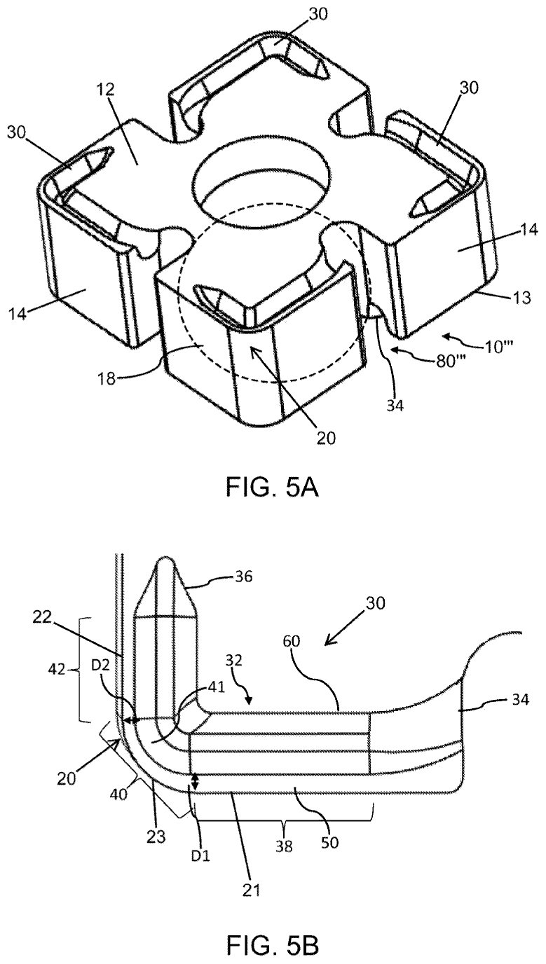

In the cutting insert 10 and 10′ of FIGS. 1A, 1B and 2A, 2B each nozzle receiving through bore 80 and 80′ is located in the middle, between two adjacent cutting corner regions, e.g. a first cutting corner region 18 of a first cutting edge 21 and a second cutting corner region 18 of a second cutting edge 22. In a cutting insert 10″ of FIGS. 3A to 3D, the nozzle receiving through-bore constitutes a portion of the mounting bore 15″, and in a cutting insert 10″′ of FIG. 5A-5B, each nozzle receiving through bore 80″ is opened to the exterior of the cutting insert 10″′ at the sidewall 14 closest thereto.

In FIGS. 3A to 3F, there is illustrated a cutting insert 10″ with a nozzle receiving through-bore 80″ constituting a portion of its mounting bore 15″ with a nozzle 90″ fitted therein. The cutting insert 10″ has a diamond shape with two opposing cutting corner regions 18 on each horizontal surface 12 and 13 thereof. The nozzle receiving through-bore 80″ of this cutting insert 10″ has two cooling channels 32″, each facing an opposite cutting corner region 18, and being connected to the central mounting bore 15″ via two opposing coolant inlet portions 35 interconnecting the upstream sections 38 of their corresponding cooling channels 32″ with the mounting bore 15″. The cutting insert 10″ of this example further comprises an inlet cover 410, corresponding to each horizontal surface 12 and 13 of the cutting insert 10″ (i.e., upper and lower inlet covers 410′and 410″), and attachable thereto by a plurality of connectors 413. The inlet cover 410 is configured to cover the exterior facing portion of the coolant inlet end 34, and optionally, at least a portion of the cooling channel 32 as well, while directing coolant into the cooling channel 32. In further examples, the inlet cover 410 can also direct the coolant flowing into the cooling channel 32 towards the channel bottom by inlet ramps 411 (FIG. 3F) protruding from an insert facing side 412 of the inlet cover 410, for further preventing coolant from escaping the cooling channel 32.

The cutting insert 10″ is shown in FIGS. 3A and 3C positioned onto the base plate 100′ and having the coolant dispensing nozzle 90″ fitted within its mounting bore 15′, specifically, fitted about half of the size of the mounting bore 15′, e.g. semi-cylindrical, leaving enough space for enabling mounting of the cutting insert 10″ to occur. As shown, the base plate 100′ comprises a nozzle receiving recess 110″ about its center. While the base portion 91″ of the coolant dispensing nozzle 90″ remains about same, the elongated hollow body 95 is shaped as a semi-circle in cross section or semi-cylindrically. The nozzle outlet 98 of the coolant dispensing nozzle 90″ is directed away from its cutting corner region 18, in contrast to the nozzles 90 and 90′ of FIGS. 1D and 2D.

As aforementioned, the mounting bore 15″ can be configured to enable a portion of a clamping device 310 to be received therein, while applying force on at least one of the sidewalls and/or bottom of the mounting bore 15″, so as to fixedly attach the cutting insert 10″ to the cutting tool holder 300 to which the clamping device 310 is connected.

It should be appreciated that a cutting insert having a cooling channel according to the presently disclosed subject matter can be used in any type of cutting operation.

FIGS. 4A and 4B illustrate an assembly, for use with e.g., a turning operation, the assembly comprising a cutting tool holder 300 that is configured to be used with a cutting insert 10, 10′, 10″ or 10″′ of the kind shown in FIG. 1A and 2A, 3D or 5A, and a base plate 100 or 100′ of the kind shown in FIGS. 2A and 3A, which thereby constitute cutting tool holder 300. The cutting tool holder 300 comprises a clamp 310 rotatably attached thereto, in a manner allowing the clamp 310 to securely attach the cutting insert 10, 10′, 10″ or 10″′ thereto. The cutting tool holder 300 further comprises the base plate 100 or 100′, for example made of Widia, disposed between the cutting insert 10, 10′, 10″ or 10′″ and a seat surface 302 of the tool holder 300. It will be appreciated that features described herein with reference to and/or illustrated in the accompanying drawings, and/or recited in the appended claims, as constituting elements of the base plate 100, may be provided on the tool holder 300, and vice versa.

The clamp 310 has a front tip 312 configured to be received in the mounting bore 15, 15′ or 15″ of the cutting insert 10, 10′, 10″ or 10″′. The cutting tool holder 300 further comprises a cooling provisioning arrangement. The cooling provisioning arrangement comprises a conduit, for example along the length of the tool holder 300, and has a discharge end 304, to which the base plate 100 or 100′ can be connected via a screw, for example, threaded into bore 306.

The coolant dispensing nozzle 90, 90′ or 90″ is disposed between the corresponding base plate 100 or 100′ and the corresponding cutting insert 10, 10′, 10″ or 100″′, configured with the corresponding base portion 91, 91′ or 91″ configured to be snuggly received in the base plate 100 or 100′ and having the base mounting bore 92, and the elongated hollow body 95 configured to be threaded/inserted, either snuggly or loosely, from both sides of the corresponding nozzle receiving through-bore 80, 80′ or 80″ of the corresponding cutting insert 10, 10′, 10″ or 10″′. In this example, coolant is provided, via the tool holder 300, through the base plate 100 or 100′, by the corresponding coolant dispensing nozzle 90, 90′ or 90″ to the cooling cavity 30 of the corresponding cutting insert, 10′, 10″ or 10″′.

FIG. 5A illustrates a cutting insert 10″′ which differs from the previously described cutting inserts 10, 10′ or 10″ in that each nozzle receiving through-bore 80″′ is formed as a vertical trough formed in the sidewalls 14, providing it with a lateral opening, as in the nozzle through-bore 80 of FIG. 1. FIG. 5B illustrates an enlarged view of the cooling cavity 30. As aforementioned, the outer coolant directing wall 50 extends along the cutting edge 20 while balancing the proximity to the cutting edge 20. As shown, the distance between the upstream section 38 to the first cutting edge portion 21 is a first distance D1, and the end of the curved section 40 the outer coolant directing wall 50 is distanced from the corner cutting edge portion 23, specifically to the area thereof meeting the second cutting edge portion 22 (the point where the corner ends) to a second distance D2, smaller than the first distance D1. For example, the distance D1 can be about 0.3 mm and D2 can be about 0.2 mm.

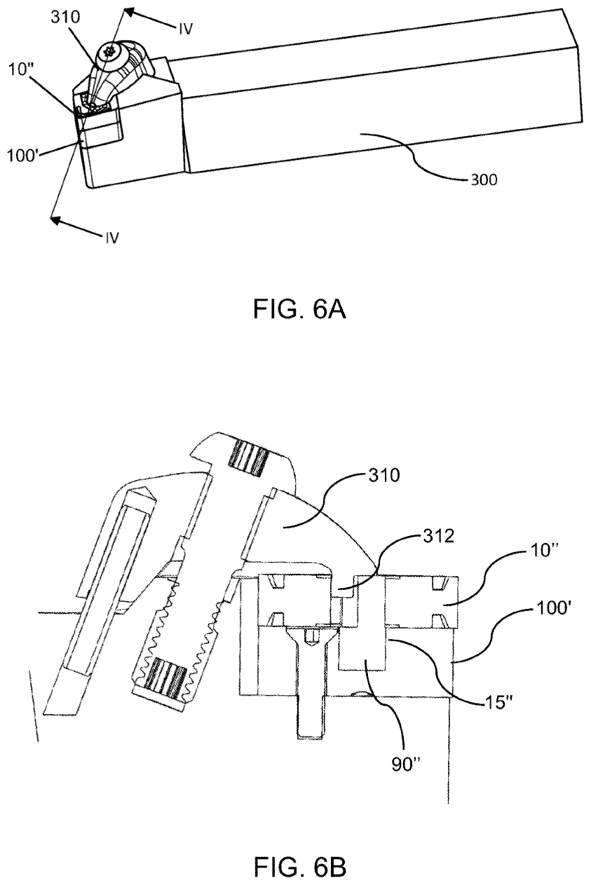

FIGS. 6A and 6B illustrate the use of the base plate 100′ for mounting thereon the cutting insert 10″ and the coolant dispensing nozzle 90″ of the kind illustrated in FIGS. 3A to 3F, where the front tip 312 of the clamp 310 is dimensioned to be positioned within the space formed between the coolant dispensing nozzle 90″ and the mounting bore 15″.

Cooling channels 32 in cutting inserts 10, 10′, 10″ or 10″′ according to the presently disclosed subject matter can have their shape in a plan view of the cutting insert, and their cross-sectional shape at different locations along the length thereof, designed to meet different purposes.

For example, the outer coolant directing wall 50 can have an orientation with respect to the corresponding horizontal surface 12 or 13, such as to function as a banked turn, mitigating the spillage of coolant flowing along the cooling channel 32 from the upstream section 38 to the downstream section 42. The curvature of the curved section 40 can be same throughout the entire section thereof, or it can decrease towards the downstream section 42 in order to reduce the spacing, and hence the amount of material, between the cooling channel 32 and the curved corner cutting edge portion 23. The downstream section 42 can have a depth gradually decreasing towards the coolant outlet end 36, which can be flush with adjacent areas of the corresponding horizontal surface 12 and 13.

In examples of a cutting insert 10, 10′, 10″ and 10″′ of the presently disclosed subject matter where the cooling channel 32 has only an outer coolant directing wall 50, the height of the wall 50 can vary along the upstream, curved, and downstream sections 38, 40 and 42, respectively, of the cooling channel 32. In examples of a cutting insert 10, 10′, 10″ and 10″′ of the presently disclosed subject matter, where the cooling channel 32 has outer and inner coolant directing walls 50 and 60, respectively, each having a wall top and a wall bottom, the cooling channel 32 having a channel bottom 70 extending between the bottoms of the two walls 50 and 60, the depth of the cooling channel 32 can vary along its length, as well as its geometry. In some cases, the channel bottom 70 can be concaved or inclined to match the curvature or inclination of the walls 50 and 60.

Consequently, the outer coolant directing wall 50 can be configured to provide balance between two contradicting features: being as close as possible to the cutting edge 20 for increasing heat removal and leaving the minimal amount of insert material between the cooling channel 32 and the closest sidewall 14 necessary to prevent weakening of the cutting edge 20. In particular, the distance between the cooling channel 32 and its corresponding cutting edge 20 may vary, depending on the forces applied during the cutting operation thereon. For example, the upstream section 38 can be spaced from the first cutting edge 21 to a first distance D1, and the end of the curved section 40 can be spaced from the cutting corner edge portion 23 to a second distance D2, smaller than the first distance.

The cooling channel 32 has a channel bottom 70 connecting the outer and inner coolant directing walls 50 and 60 and spaced from the corresponding horizontal surface 12 or 13. In this example, the depth of the cooling channel 32 is the same in the upstream section 38 and the curved section 40, and gradually decreases along the length of the downstream section 42 away from the curved section 40. For example, the depth of the cooling channel 32 can be between 0.5 mm to 1 mm at the upstream and curved sections 38 and 40, and gradually decrease to 0 at the coolant outlet end 36, thereby becoming flush with the corresponding horizontal surface 12 or 13.

In cases where more efficient cooling is required in a specific region of the cooling channel 32, such as the area of merging between the curved section 40 and the downstream section 42 of the cooling channel 32, e.g., at the area of the channel 32 where the curved portion 40 ends, this region of the cooling channel 32 can be formed as a cooling bay. The cooling bay can be characterized by having geometry of the outer coolant directing wall 50 therealong, different from that of the other areas of the wall. For example, the cooling bay can be characterized by the outer coolant directing wall 50 being closer to the associated cutting edge portion, e.g. the second cutting edge portion 22, and/or having a larger distance from the inner coolant directing wall 60, and/or having a larger slope towards the associated cutting edge, than at other areas of the outer coolant directing wall 50. The cooling bay can have minimal spacing from the cutting edge 20 associated with a maximal inclination of the outer coolant directing wall 50. According to embodiments of the presently disclosed subject matter, the cooling surface can be disposed at the cooling bay, particularly, on the coolant directing wall 50.

The cooling bay can differ from the remainder of the insert 10, 10′, 10″ or 10″′ in the surface treatment when the cutting insert is manufactured. For example, the portion of the cooling channel with the cooling bay, and particularly the cooling surface 41, can be manufactured without coating, or with a different coating than the first coating material—to increase the heat removal capacity/performance in that area.

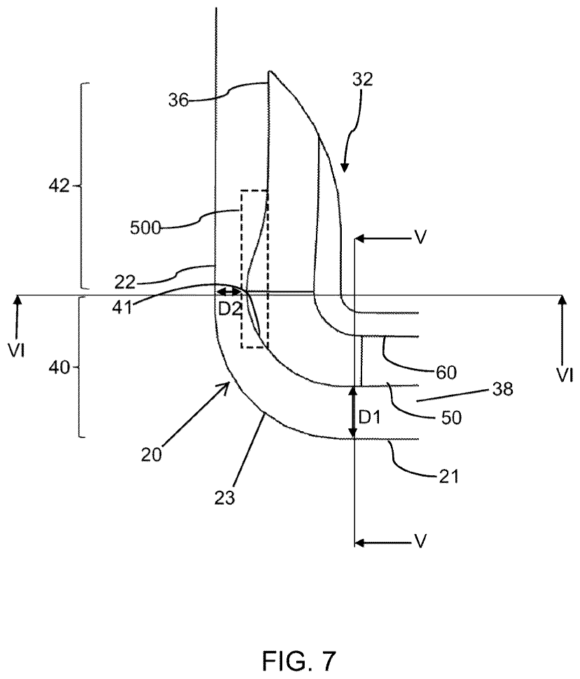

FIG. 7. illustrates one example of a cooling channel 32 with a cooling bay portion 500, formed at the merger between the curved section 40 and the downstream section 42 of the cooling channel 32. Specifically, the cooling bay portion 500 is distanced from the corresponding cutting edge 22 at a smaller distance D2 than the first cutting edge 21 of the upstream section 38, and less material is positioned at the between the outer coolant directing wall 50 and the corresponding cutting edge, typically the curved cutting edge portion 23 or the second cutting edge portion 22. As shown the inclination of the outer coolant directing wall 50 increases the merger between the upstream section 38 and the curved section 40, in which the outer coolant directing wall 50 is spaced to a first distance D1 from the first cutting edge portion 21, towards a portion of the cooling channel 32 where the curved section 40 and the downstream section 42 merges, in which it is spaced to a second distance D2 from the second cutting edge portion 22, being smaller than D1.

Each of the outer and inner coolant directing walls 50 and 60, respectively, of the cooling channel 32 according to the presently disclosed subject matter can have a varying inclination angle relative to a horizontal plane along at least a part of the cooling channel 32. This angle can vary continuously, in which case the corresponding wall 50 and 60 can be continuously curved, or rather the coolant directing wall 50 and 60 can have a number of planar wall surfaces having different inclination angles. For example, each of the outer and inner coolant directing walls 50 and 60 can have a lower wall surface comprising the wall bottom and an upper wall surface comprising the wall top, wherein the angle of inclination of the upper wall surface of any of the walls 50 and 60 can be smaller than that of the lower wall surface, with respect to a horizontal plane. In some cases, the upper wall surface can have a larger height than that of the lower wall surface allowing the former surface to constitute a chip breaking surface.

Instead of different inclination, the cooling bay portion can have two topographic regions defined in the outer or inner coolant directing walls. Such lateral topographic regions can comprise a beveled face, forming an angled protrusion or recess in the corresponding walls. Such a lateral topographic region can run parallel to at least some of the length of the cooling channel, more specifically, at least about the curved section thereof.

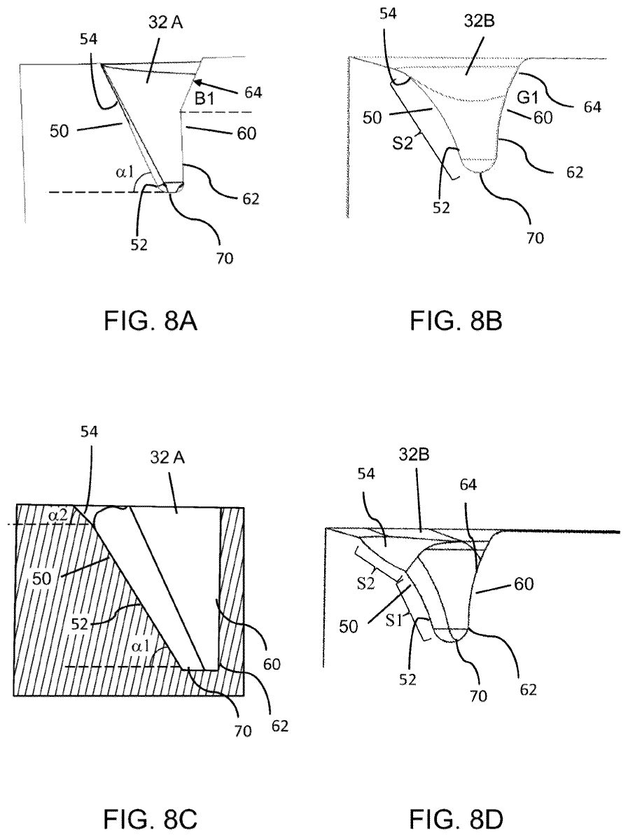

FIGS. 8A to 8D illustrate two examples of coolant directing walls 50 and 60 with varying topography along their length due to cooling bay portions. FIGS. 8A and 8C illustrate a first cooling channel 32A, while FIGS. 8B and 8D illustrate a second cooling channel 32B. In FIGS. 8A and 8B, cross sectional views of exemplary cooling channels 32A and 32B, respectively, are shown, viewed from a line matching the position of line V-V of FIG. 7. In FIGS. 8C and 8D, cross sectional views of exemplary cooling channels 32A and 32B, respectively, are shown, viewed from a line matching the position of line VI-VI of FIG. 7.

The inner coolant directing wall 60 of the cooling channels 32A, and 32B comprise a lower wall surface 62 having vertical or close to vertical orientation in all sections of the cooling channels 32A and 32B, and an upper wall surface 64 inclined (8A) or curved (8B) to the horizontal plane at an angle B1/curvature G1 in the direction away from the outer coolant directing wall 50 at the upstream sections 38 of their respective cooling channels 32A and 32B. In FIG. 8B, the upper wall surface 64 slightly protrudes upwardly from the level of the outer coolant directing wall 50, about the level of its corresponding rake surface 21ᵣₐₖₑ, which is inclined in this example, so that when a cutting insert 10, 10′, 10″ or 10″′ having coolant directing walls 50 and 60 is mounted in a cutting tool 300, the upper wall surface 64 is capable of functioning as a chip breaker.

The outer coolant directing wall 50 of the cooling channels 32A and 32B of FIGS. 8A and 8B, forms, with respect to the horizontal plane, a first inclination angle al, and first curvature S1, respectively, at the merger between the upstream section 38 and the curved section 40. However, at the cooling bay portion 500 at the merger between the curved section 40 and the downstream section 42, the outer coolant directing wall 50 of the cooling channel 32A (FIG. 8C) has a lower wall surface 52 with the first inclination angle al and an upper wall surface 54 with a second inclination angle α2 smaller than the first inclination angle a1. At the same location (FIG. 8D), the second cooling channel 32B includes an upper wall surface 54 with a second curvature S2 being opposite (i.e., convex) to the first curvature S1 (which is concave).

As mentioned above, cutting inserts according to the presently disclosed subject matter can be used with cutting tools designed for any cutting operation.

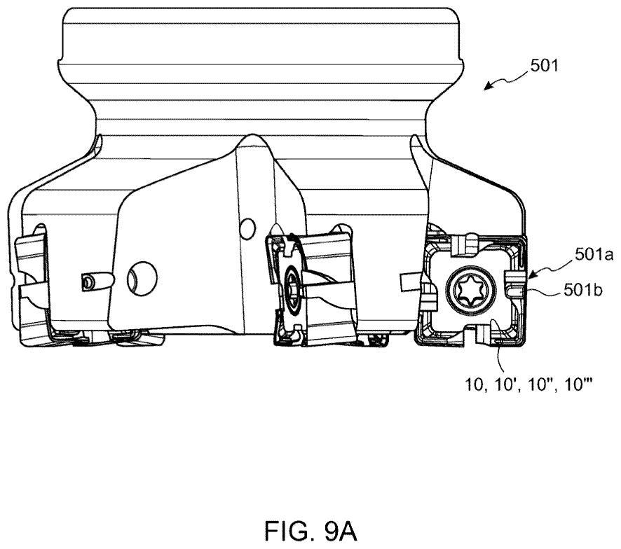

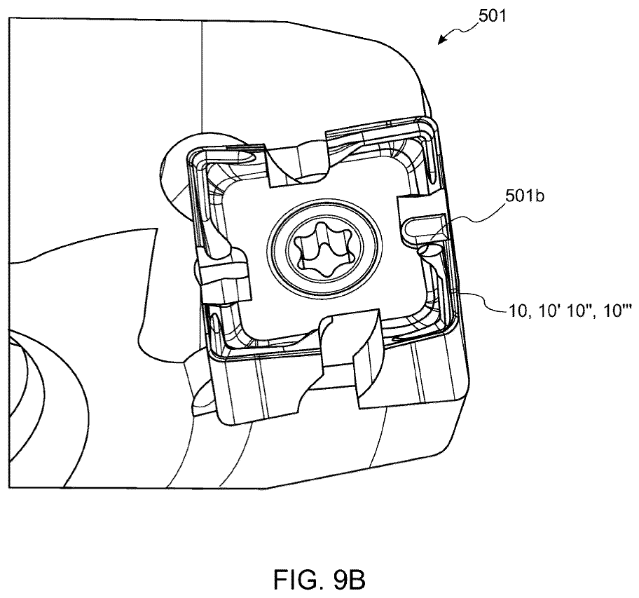

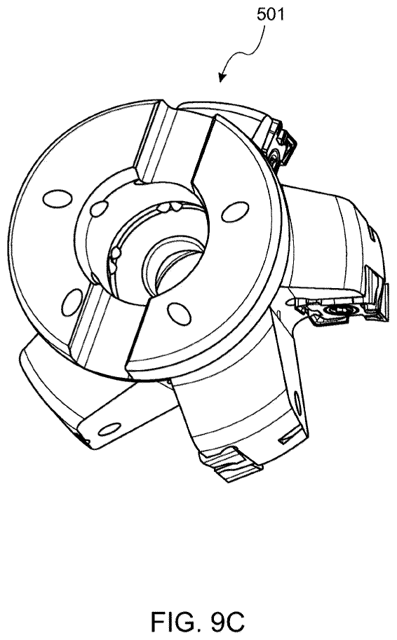

FIGS. 9A to 9C Illustrate an example of a milling tool where a plurality of inserts 10, 10′, 10″ or 10″′ of the kind described above are mounted to corresponding seats 501a of the milling tool holder 501. The holder 501 comprises a nozzle 501b associated with each seat 501a. Cooling fluid flows to each nozzle via a designated inlet 502. The inlet 502 being positioned at a center of the milling tool holder 501. The milling tool holder further comprises a secondary inlet and nozzle 503a,503b respectively, for flowing of cooling fluid to be dispensed directly on the workpiece being processed.

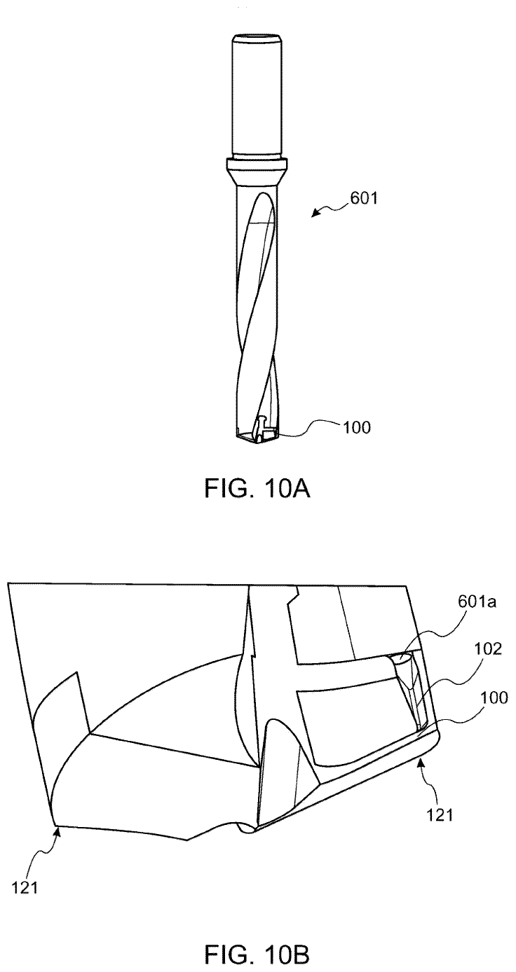

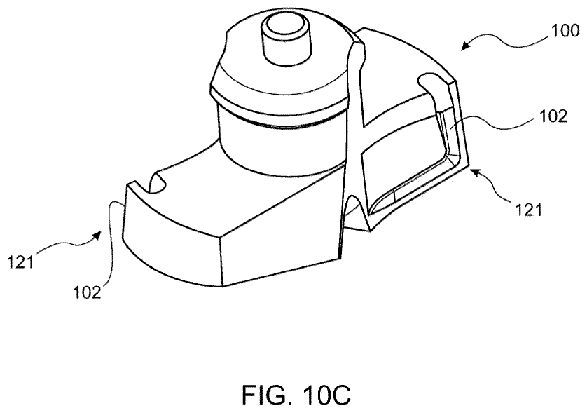

FIGS. 10A and 10B Illustrate an example of a drilling tool comprising a drilling tool holder 601 and a cutting insert 100 according to the presently disclosed subject matter, shown separately in FIG. 10C and having cooling channels 102 of the kind described above with respect to cutting inserts 10, 10′, 10″ or 10″′. The insert 100 comprises two cutting edge portions 121, and hence two cooling channels 102. The holder comprises two nozzles 601, each associated with an upstream end of a respective channel 102. Cooling fluid flows via respective inlets (not shown) positioned atop the drilling tool holder, through the drilling tool holder, and through the nozzles 601 into each channel 121.

A cutting inset according to the presently disclosed subject matter can also be constituted by a complete end mill, or an end mill with indexable head, where the cooling channel is formed at least partially at a cutting portion/cutting corner of the end mill/end mill head.

In all the cutting inserts described above, the cooling channel/s can include a coating to increase durability thereof.

The coated cooling channels will be described below with reference to only one kind of cutting inserts of the presently disclosed subject matter, but this description is applicable to any other kind of cutting insert according to the presently disclosed subject matter, including the cutting inserts described above.

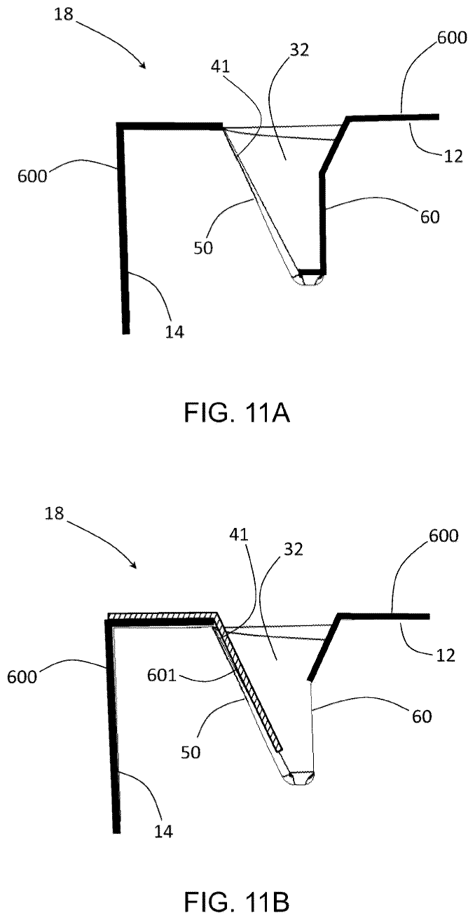

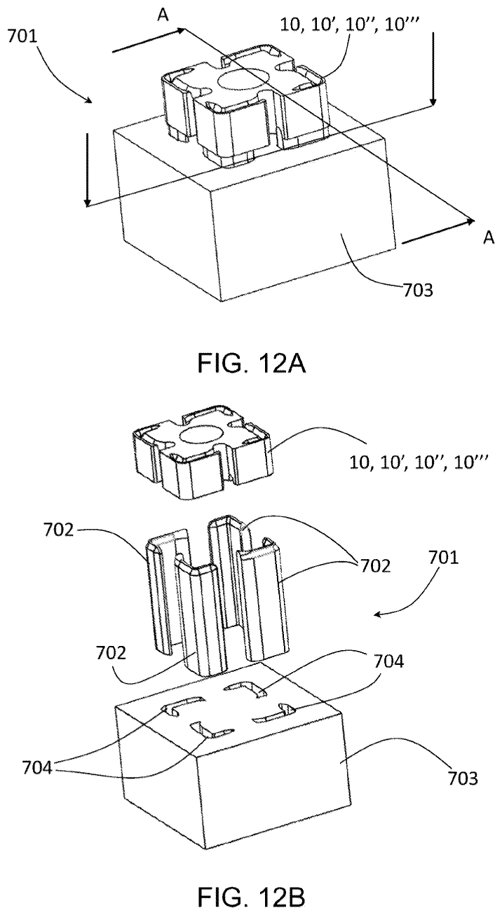

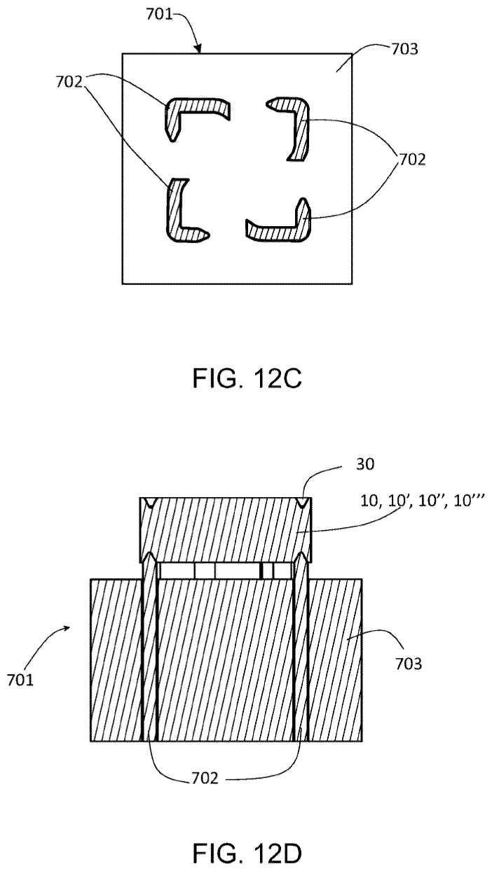

With reference to FIGS. 11A and 11B, an exemplary coating the cutting insert 10, 10′, 10″, 10″′ or any suitable cutting insert is illustrated. Typically, the entire insert 10, 10′, 10″, 10″′, and particularly, the cutting corner region 18 thereof is coated with the first coating material to increase durability; however, the coating may decrease the thermal conductivity of the cooling surface 41 over which the cooling fluid flows to absorb heat from the cutting corner region 18, thereby reducing the effectiveness thereof. The present disclosure increases the thermal conductivity of the cooling surface 41 by leaving the cooling surface free of the coating material, which covers the remainder of the cutting corner region 18.

For effective heat removal, the cooling surface 41 may be defined on the fluid directing wall 50, in the cooling bay, when the latter exists. According to some embodiments of the presently disclosed subject matter, the entire curved section 40 of the cooling cavity 32 can be free of the first coating material, and generally, the entire cooling cavity 32 can be free of the first coating material.

Accordingly, the cutting insert, e.g. 10, 10′, 10″ or 10″′, comprises the upper surface 12, the lower surface 13 and a plurality of side surfaces 14 extending therebetween, the plurality of side surfaces 14 including a first side surface and a second side surface adjacent to the first side surface. The cutting corner region 18 is defined between the first side surface 14, the second side surface 14 and one of the upper surface 12 and the lower surface 13, e.g. upper surface 12. The cooling cavity 30, including the cooling surface 41, e.g. outer coolant directing wall 50 and/or inner coolant directing wall 60, proximal to the cutting corner region 18, is configured for receiving therein a cooling fluid for cooling the cooling surface 41, e.g. outer coolant directing wall 50 and/or inner coolant directing wall 60, and thereby withdraw heat from the cutting corner region 18. A first coating material 600 is provided on the cutting corner region 18; however, at least at the cooling surface 41 of the cooling cavity 32 is free of the first coating material 600, e.g. to provide better thermal conductivity thereat.

In the non-limiting exemplary embodiments (FIG. 11A), the cooling cavity 30 comprises the channel 32 including the coolant inlet end 34 and the coolant outlet end 36 different from the coolant inlet 34, and the cooling surface 41 disposed therebetween. The cooling cavity 30 extends inwardly from one of the upper surface 12 or the lower surface 13.

The cooling cavity 30 has at least a surface, e.g. outer coolant directing wall 50 and/or inner coolant directing wall 60, exposed to the exterior of the cutting insert, e.g. 10, 10′, 10″ or 10″′, which is free from being coated with the first coating material 600. In some exemplary embodiments, the cooling surface 41, e.g. the outer coolant directing wall 50, of the cooling cavity 30, is exposed to the exterior of the cutting insert 10, 10′, 10″, 10′″. In some exemplary embodiments, the cooling surface, e.g. the outer coolant directing wall 50 and/or the inner coolant directing wall 60, also faces in the direction of the exterior of the cutting insert 10, 10′, 10″, 10″′, providing increased heat transfer from radiation and convection.

In some exemplary embodiments, (FIG. 11B) the entire cooling cavity 30, e.g. the outer coolant directing wall 50 and the inner coolant directing wall 60, is free of the first coating material 600, in which case the heat transfer properties of the cooling cavity 30 are maximized, i.e. not limited by the first coating material 300; however, in some embodiments, (FIG. 11B) at least a portion of the cooling cavity, e.g. the upper wall surface 64, may be provided with the first coating 600, while the remaining cooling cavity 30, e.g. the outer coolant directing wall 50 and the lower wall surface 62 remain free of the first coating 600, which provides a combination of both heat transfer properties (where there is no first coating 600) and durability (where there is first coating 600).

The cooling cavity 30, e.g. the cooling channel 32, extends from a corresponding one of the upper surface 12 and the lower surface 13, and is encompassed by the corresponding one of the upper surface 12 and the lower surface 13. At least a portion of the corresponding one of the upper surface 12 and the lower surface 13, including the cutting corner region 18, is coated with the first coating material 600. In some embodiments, the entire corresponding one of the upper surface 12 and the lower surface 13 encompassing the cooling cavity 30 are coated with the first coating material 600, which may, for example, provide increased durability for the cutting insert, in particular the cutting corner region 18. At least a portion of the cutting corner region 18, e.g. the outer coolant directing wall 50 and the inner coolant directing wall 60, may be provided with a second coating 601 to further increase the thermal conductivity of the cooling cavity for increasing the amount of heat transfer form the cutting corner region 18 to the cooling fluid.

The cutting insert, e.g. 10, 10′, 10″ or 10″′, comprises the central axis X extending normal to the one of the upper surface 12 and the lower surface 13, wherein each cooling cavity 30 extends along an axis perpendicular to the central axis X towards each corresponding cutting corner region 18.

Each cooling channel 32 comprises an upstream section 38 associated with the coolant inlet 34, extending towards the cutting corner region 40 along and spaced from the first side surface 14, a downstream section 42 associated with the coolant outlet 36, extending away from the cutting corner region 23 and extending along and spaced from the second side surface 14, and a curved section 40 associated with the cooling surface interconnecting the upstream section 38 and the downstream section 42.

In some exemplary embodiments, the cooling cavity 30 comprises a cavity having a single opening comprising both the coolant inlet and the coolant outlet. Alternatively, in other exemplary embodiments the coolant inlet and the coolant outlet are separate.

In some exemplary embodiments, the cooling cavity 30 has a maximal depth which is less than half the distance between the upper surface 12 and the lower surface 13. In some exemplary embodiments, the cutting insert, e.g. the cutting insert 10, 10′, 10″, 10′″, comprises a material having a first thermal conductivity, wherein the first coating material 600 has a second thermal conductivity lower than the first thermal conductivity, which increases the durability of the cutting insert, but reduces the thermal conductivity thereof, i.e. the ability to transfer heat from the cooling cavity to the cooling fluid.

In some exemplary embodiments, the boundaries between coated and uncoated portions of the cutting insert, e.g. cutting insert 10, 10′, 10″, 10″′, are distinct from each other.

In some exemplary embodiments, the cooling cavity 30, at least at the cooling surface, e.g. the outer coolant directing wall 50 and/or the inner coolant directing wall 60, is coated with the second coating material 601 different from the first coating material 600 of the cutting corner region 18; however, alternatively the cooling surface, e.g. the outer coolant directing wall 50 and/or the inner coolant directing wall 60, is not coated with any coating material. The first coating 601 and/or the second coating 602 may provide increased durability and/or increased thermal conductivity and/or some other characteristic that is beneficial to the cutting insert, e.g. cutting insert 10, 10′, 10″, 10″′; however, the first coating 601 and/or the second coating 602 may decrease thermal conductivity of the cooling cavity 30, in which case should be prevented from being deposited therein.

With reference to FIGS. 10 and 11, a masking arrangement is shown for use in the coating process for coating the first coating 600 and/or the second coating 601 of the cutting insert, e.g. cutting insert 10, 10′, 10″, 10″′ or other suitable cutting insert, while preventing the first coating 600 and/or the second coating 601 from coating selected portions of the cooling cavity 30, e.g. the outer coolant directing wall 50 and/or the inner coolant directing wall 60. The masking arrangement 701 comprises at least one masking element 702 comprising at least one fitting portion 702a having corresponding dimensions to at least a portion of the cooling cavity 30 including the cooling surface 41, so as to be able to snuggly fit thereinto, and mask at least the cooling surface 41 during said coating process. In cases where a plurality of cooling cavities 32 should be masked by the masking arrangement, a number of masking elements 702 corresponding to the number of cooling cavities 30 can be used. In cases where the cooling cavities 30 of the same insert are identical, identical masking elements 702 can be used as well. Alternatively, a single masking element having a number of fitting portions 70a can be used. The at least one masking element 702 is configured for mounting in the cooling cavity 30 during the coating process such that said fitting portion 702 covers and thereby protects said cooling surface 41 from being coated. Accordingly, the rest of the cutting insert 10, 10′, 10″, 10′″, and particularly the cutting corner region 18 is coated, and optionally forms a distinct border between the coated and uncoated regions, i.e. the cooling cavity 30 and the outer portions of the cutting corner region 18.

To enable the rest of the insert 10, 10′, 10″, 10″′ to be coated, the masking element can be rigid so as to support the cutting insert from below, and have a length greater than a depth of the cooling cavity 30.

In the illustrated exemplary embodiment of FIGS. 10A to 10D, the masking arrangement 701 includes a plurality of masking elements 702, e.g. one for each of the cooling cavities 30. A base 703 is provided for supporting the fitting portions 702 in an upright position. The rigid masking elements 702 support the insert 10 from below, while keeping it spaced from the base 703, to enable coating of the lower surface thereof. In the illustrated exemplary embodiments the base 703 includes recesses 704 configured to receive one end of the fitting portions 702, while the outer free ends extend upwardly therefrom for receiving the cooling cavities 30 of the cutting insert. A modular arrangement including the separate base 703 and the fitting elements 702 enable much easier cleaning of the individual components and enable different fitting portions 702a, e.g. for different cooling cavities 30, to be utilized with the same base 703. Moreover, the position of the fitting elements 702 may be individually adjusted for each cooling cavity 30, providing a much greater tolerance for misalignment of the cutting inserts 10 and the fitting elements 702.

With reference to FIGS. 11A and 11B, the cutting inserts, e.g. cutting inserts 10, 10′, 10″, 10′″ may be stacked in a superposed position during the coating process. In such case each masking element 702 can have two, optionally corresponding, fitting portions 702a, whereby each of the fitting elements 702 of the masking arrangement 701 are configured to be mounted in or on the cooling cavity 30 of a first cutting insert 10a, and to be mounted in or on the cooling cavity 30 of the second cutting insert 10b, and thereby support the second cutting insert 10b in a spaced apart manner with respect to the first cutting insert 10a. To achieve such, each masking element can be rigid and have a length greater than the depth of the two cooling cavities in which its fitting portions 702a are mounted.

The fitting portions 702a may have a tapered shape with an edge having dimensions smaller than the width of the cooling cavity, to facilitate easy fitting thereof to the cooling cavity 30.

In the exemplary illustrated embodiment, the second cutting insert 10b is identical to the first cutting insert 10a; however, the cutting inserts may be somewhat different, as long as the fitting portions 702 cover the corresponding portions of the cooling cavities 30 to be uncoated or coated with a different material. In the exemplary illustrated embodiment, the masking element 702 comprises the first fitting portion 702a positioned at a first end of the masking element 702, e.g. extending between cooling cavities 30 in the first cutting insert 10a and the second cutting insert 10b, and a second fitting portion 702b positioned on an opposite end thereof, e.g. extending from cooling cavities 30 in an opposite side of the first cutting insert 10a, configured to fit within a cooling cavity 30 of the third cutting insert 10c.

The plurality of masking elements 702 may be configured with an identical shape, e.g. L-shaped cross-section, for fitting into the cooling channel 32, e.g. the upstream section 38, the curved middle section 40 and the downstream section 42 of each cooling channel 32, which matches the same shape, e.g. L shaped, as the end thereof including the fitting portion 702; however, the plurality of fitting portions 702 may be positioned differently relative to one another, e.g. adjacent fitting portions 702 are rotated by 90° relative to each other.

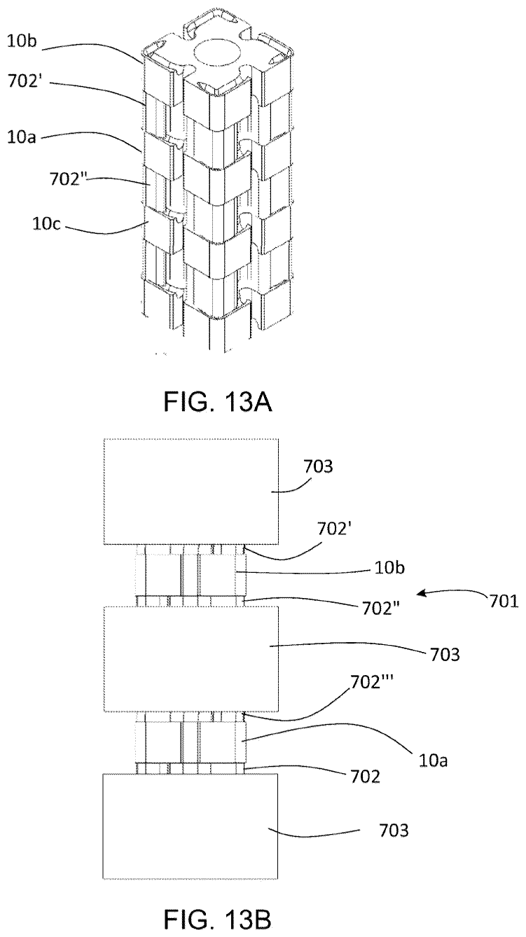

The masking arrangement 701 may further comprise said base 703 (FIG. 13A) supporting a single cutting insert, or a plurality of stacked and superposed cutting inserts 10a, 10b and 10c with sets of masking elements 702a, 702b etc. extending therebetween. The masking arrangement 701 comprises the base 703 having one or more fitting sockets or recesses 704, and a corresponding number of independent masking elements 702 fitted therein.

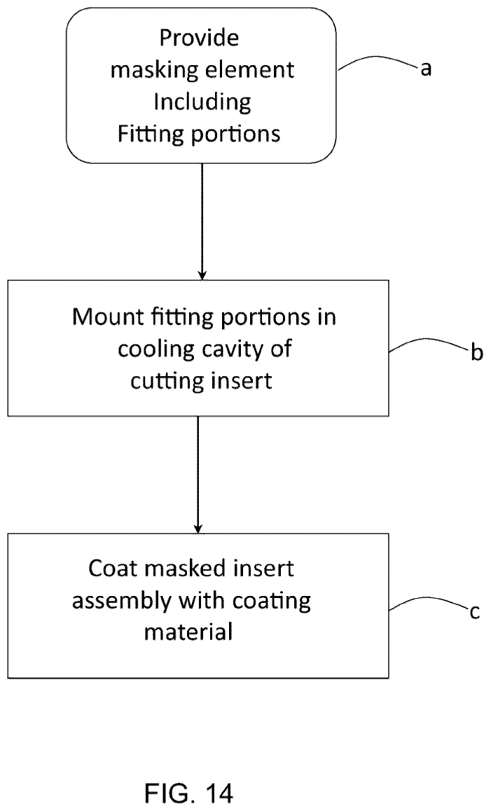

With reference to FIG. 14, a method for partially coating at least one cutting insert 10, 10′, 10″ or 10″′, hereafter just 10, comprising an upper surface 12, a lower surface 13 and a number of side surfaces 14 extending therebetween, and comprising a cutting corner region 18 defined between two, first and second, adjacent side surfaces 14 and one of the upper surface 12 and the lower surface 13, and a cooling cavity 30 having a cooling surface, e.g. the outer coolant directing wall 50 and/or the inner coolant directing wall 60, proximal to the cutting corner region 18, the cooling cavity 30 being configured for receiving therein a cooling fluid for cooling said cooling surface 41 and thereby withdraw heat from the cutting corner region 18, the method comprising:
a) providing a masking arrangement 701 including at least one masking element 702 having a fitting portion 702a with corresponding dimensions to at least a portion of the cooling cavity 30 including the cooling surface;
b) mounting the masking elements 702 by their fitting portions 702a in the cooling cavity 30 of the cutting insert 10 such that the fitting portion 702 covers the cooling surface to form a masked insert assembly;
c) coating the masked insert assembly with the first coating material 600 having a lower heat conductivity value than that of the cutting insert 10.

It should be appreciated that the mounting in step (b) can be performed such that the cutting insert is supported from below by the masking elements 702, in a spaced apart manner from a base or a different insert on which the masking elements 702 are mounted.

For coating a plurality of cutting inserts 10, the masking arrangement 701 comprises a plurality of masking elements 702, each configured to be mounted with and support one of the plurality of cutting inserts 10 in a cojoined manner with other masking elements. Accordingly, the method may further comprise, prior to step (c), stacking the masking elements 702 and the cutting inserts 10, such that the cutting inserts 10 are spaced from each other by the masking elements 702, eliminating the need for a plurality of bases 703 and providing suitable access to the areas of the cutting corner region 18 that is being coated. As during a normal coating process, the cutting inserts typically rotates, providing a plurality of masking elements also helps preventing undesired rotation about each masking element.

The term “coating” is presented throughout the specification and claims refers to a known in the art process for coating cutting inserts, and particularly to coating by vapor, e.g., CVD (Chemical Vapor Deposition) and PVD (Physical Vapor Deposition). In such process, the cutting insert is placed within an oven to which coating material vapor is applied, coating every part of it which is not masked. The coating materials can be any suitable coating materials which can be applied using the above-described process, and can benefit the cutting insert in any term, e.g., heat transfer.

The masking element 702 can also be made of metallic material to enable grounding of each cutting insert in which it is in contact with, therethrough.

1-58. (canceled)

59. A cutting insert, comprising:
a body having a pair of upper and lower parallel horizontal surfaces and at least three sidewalls extending therebetween, the body further including at least one cutting corner region defined between two, first and second, adjacent sidewalls and the upper horizontal surface, and a cooling portion associated with said cutting corner region, said cutting corner region having a rake surface at the corresponding horizontal surface, a first relief surface at the first side sidewall, a second relief surface at the second sidewall, and having respective first and second cutting edge portions and a curved cutting edge portion therebetween, each cooling portion including:
a cooling channel formed in the corresponding horizontal surface, open to an exterior of the insert along a depth thereof, the cooling channel extending between a coolant inlet and a coolant outlet and comprising an upstream section associated with the coolant inlet, extending towards the curved cutting edge portion along and spaced from the first cutting edge portion, a downstream section associated with the coolant outlet, extending away from the curved cutting edge portion and extending along and spaced from the second cutting edge portion, and a curved section interconnecting the upstream and downstream sections and extending along the curved cutting corner and spaced therefrom; and
a through-aperture extending from the lower horizontal surface towards the upper horizontal surface, such that the coolant inlet merges with the through-aperture, so as to allow coolant to flow therein from at least the lower horizontal surface into the cooling channel via the coolant inlet in order to facilitate heat removal from the cutting corner region.

60. The cutting insert of claim 59, wherein the curved section of the cooling channel is spaced from the cutting edge to a distance at least not exceeding that of the upstream section.

61. The cutting insert of claim 59, wherein the cooling channel has a channel bottom, a first wall, and a second wall extending from the channel bottom to the corresponding horizontal surface, the first wall being closer to the cutting edge than the second wall.

62. The cutting insert of claim 61, wherein the inclination of the first wall relative to a horizontal plane passing through the channel bottom, varies so that in the curved section the inclination is greater than adjacent to the coolant inlet.

63. The cutting insert of claim 61, wherein the second wall comprises a chip breaking formation at an area of the second wall close to the corresponding horizontal surface.

64. The cutting insert of claim 59, wherein the depth of the cooling channel along at least the curved section is between 0.5 mm to 1 mm, more specifically between 0.65 to 0.85 mm, and, even more specifically, is about 0.7 mm.

65. The cutting insert of claim 64, wherein the cooling channel has a channel bottom, a first wall, and a second wall extending from the channel bottom to the corresponding horizontal surface, the first wall being closer to the cutting edge than the second wall, wherein the first and second walls have top edges and the width of the cooling channel between these top edges is in the range of 0.6 mm to 1 mm, more specifically between 0.7 to 0.8 mm, and even more specifically, is about 0.75 mm.

66. The cutting insert of claim 59, wherein the through aperture is a nozzle receiving through-aperture configured to enable a coolant nozzle to be inserted therein.

67. The cutting insert of claim 66, wherein the nozzle receiving through-aperture is configured to enable the coolant nozzle to be inserted therein only in a single orientation.

68. The cutting insert of claim 59, wherein the cutting insert is double-sided, and said cooling channel constitutes an upper cooling channel in fluid communication with the through-aperture at an area thereof adjacent the upper horizontal surface, and the cutting insert has a lower cooling channel in fluid communication with the through-aperture at an area thereof adjacent the lower horizontal surface, and wherein the through-aperture is configured to receive coolant from both upper and lower horizontal surfaces.

69. The cutting insert of claim 59, wherein the cutting insert comprises at least two cutting edges and two cooling channels at each of its upper and lower horizontal surfaces and at least two corresponding through-apertures, each associated with one upper cooling channel and one lower cooling channel.

70. The cutting insert of claim 68, wherein the cutting insert has a central axis X and the nozzle receiving through-aperture has an aperture axis Xb defining a vertical plane with the central axis, wherein the cooling channel in the upper horizontal surface is positioned at one side of the vertical plane and the cooling channel in the lower horizontal surface is positioned at an opposite side of the plane.

71. A nozzle for use with a tool holder on which a cutting insert according to claim 59 is configured to be mounted, the nozzle being configured to be received within the through-aperture and having a proximal end to be associated with the tool holder and a distal end associated with the upper horizontal surface of the insert when the nozzle is fully received in said through-aperture, wherein the nozzle comprises an outlet orifice spaced from the distal end to a distance corresponding to the depth of the cooling channel at the coolant inlet.

72. The nozzle of claim 71, wherein the nozzle is configured for being assembled with the tool holder to which the insert is to be mounted, and optionally integrally assembled therewith.

73. The nozzle of claim 71, wherein the nozzle is unitarily formed with the tool holder.

74. The nozzle of claim 71, wherein the tool holder is a part of a tool holder assembly, which also comprises, at least in use, a base plate via which the insert is to be mounted on the tool holder, and wherein the nozzle is assembled with the base plate, and optionally integrally assembled therewith.

75. The nozzle of claim 71, wherein the tool holder is a part of a tool holder assembly, which also comprises, at least in use, a base plate via which the insert is to be mounted on the tool holder, and wherein the nozzle is unitarily formed with the base plate.

76. The nozzle of claim 71, wherein said nozzle has a vertical axis and the outlet orifice has an orifice axis oriented transversely to the vertical axis.

77. A tool holder comprising the nozzle claim 71.

78. A base plate comprising the nozzle of claim 74.
